(19) United States
(12) Patent Application Publication
(10) Pub. No.: US 2014/0278701 A1
(43) Pub. Date: Sep. 18, 2014

(54) COLLABORATION PLATFORM FOR DIGITAL MEDIA

(71) Applicant: David Bellino, Wakefield, RI (US)

(72) Inventor: David Bellino, Wakefield, RI (US)

(21) Appl. No.: 14/210,706

(22) Filed: Mar. 14, 2014

Related U.S. Application Data
(60) Provisional application No. 61/787,200, filed on Mar. 15, 2013.

(51) Int. Cl. G06Q 10/10; G06Q 10/06; G06F 21/60

(52) U.S. Cl. CPC G06Q 10/101; G06F 21/606; G06Q 10/06313
USPC 705/7.23; 705/300

(57) ABSTRACT

A collaborative platform for the procurement and creation of digital media is disclosed. The platform includes methods and systems that provide a collaborative framework for collaborative digital media, connecting government/military, industry/freelancers and academia through a common, secure cloud service. This unique solution enables a common platform for collaboration and digital media production and delivery using a secure network and data model. This framework provides a turnkey technical, creative and purchasing and procurement solution for a diverse array of organizations.

### CROSS-REFERENCE TO RELATED APPLICATION

This patent document claims priority to earlier filed U.S. Provisional Patent Application No. 61/787,200, filed on Mar. 15, 2013, the entire contents of which are incorporated herein by reference.

### BACKGROUND OF THE INVENTION

1. Technical Field

The present patent document relates generally to a system for collaborative digital media using a secure, networked cloud-based infrastructure for government/military, industry/freelancers and academia.

2. Background of the Related Art

Government contracting for digital media products can be inefficient and subject to waste, fraud and abuse. Furthermore, government contacting can be lengthy, leading to creative works that are not produced in a timely manner.

Therefore, there is a perceived need in the industry for a collaborative platform to enable efficient and cost-effective procurement of creative works.

### SUMMARY OF THE INVENTION

The present invention solves the problems of the prior art by providing a collaborative platform that connects artists and scientists of all ages to produce “next-generation collaborative digital media.” This platform offers not only a social and communication framework, but provides a collaborative environment to create, build and innovate through crowd-sourced production of digital media content.

This approach not only facilitates social networking, and connects the professional community, but uniquely blurs the lines between social and professional creative space. Through the fusion of art and science, we enable “left and right brain” talent to come together, generating a new wave in digital culture and introducing a new concept in “socio-professional” networking. This new paradigm will result in a collaborative form of visual information and communication products called “next generation collaborative digital media.” The result is a virtual workspace of the future that provides a “digital sandbox” for scientists, technologists and artists to create and innovate.

The platform will support procurement options and reform traditional acquisition of products and services using a cloud-based subscription model. This model enhances government contracting and traditional commercial acquisition. In addition, the platform will be based on a secure user and data model that will enable diverse organizations to collaborate and share information.

### BRIEF DESCRIPTION OF THE DRAWINGS

These and other features, aspects, and advantages of the present invention will become better understood with reference to the following description, appended claims, and accompanying drawings where:

FIG. 1 shows a diagram of a system for collaboration on digital media; and

FIG. 2 shows a flow chart of the process of using the system to collaborate on digital media.

### DESCRIPTION OF THE PREFERRED EMBODIMENT

Referring now to FIG. 1, a diagram illustrating the operation of the collaboration platform is shown generally. A user operating at a remote terminal 110 can interact collaboratively with resources and other users in the government/military 120, private industry/freelancers 130, and in academia 140 through the collaborative platform 100 (also branded “Atomic Cloud”). The collaborative platform 100 provides a mechanism for government/military 120 to issue contracts and procurement orders 101 for digital media 102 created by users 110, private industry/freelancers 130 and in academia 140. The collaborative platform 100 provides authentication and secure communications between the parties 110, 120, 130, 140 via a data security model 103.

It should be understood that the collaborative platform may be employed in any type of operating system. The present invention may be implemented in any type of software code using any language and can run on any type of computer hardware or networked computer hardware, including virtual machines. The computer hardware, virtual or physical, generally includes a processor, a program memory, and a data storage. The computer hardware may be networked, wired and wirelessly, to other computer hardware and accessible via other electronic devices, such as smartphones, PDAs and the like.

Digital media production solicitation posted or direct request through existing customer contract in a first step 200. A collaborative platform 100 executive producer or creative director is assigned to gather requirements and project specification from the customer, in a second step 210.

The project is then setup and a production framework crated through a user/data security model via the collaborative platform 100 infrastructure 101, 102, 103, in a third step 220. The creative team then begins the production pipeline using creative and collaboration tool set provided within the Atomic Cloud, in a fourth step 230.

The collaborative platform 100 framework provides a place to bring together all the stakeholders 110, 120, 130, 140 to establish a final technical and creative project guidelines, in a fifth step 240. The collaborative platform 100 permits a framework for digital media “production as a service” to be established, in a sixth step 250. Final contracts through automated collaborative platform procurement services is accomplished, in a seventh step 260

The collaborative platform 100 enables production execution and digital media products to be delivered through a secure framework, in an eight step 270.

It would be appreciated by those skilled in the art that various changes and modifications can be made to the illustrated embodiments without departing from the spirit of the present invention. All such modifications and changes are intended to be within the scope of the present invention.

What is claimed is:

1. A digital media collaboration platform in a networked computer environment, comprising:
a digital media framework configured and arranged for collaboration between a plurality of stakeholders on user-defined digital media creative works;
a contracts and procurement framework configured and arranged for solicitation and awarding of contacts between the plurality of stakeholders; and
a data security model configured and arranged for securing communications between the plurality of stakeholders.

2. The digital media collaboration platform of claim 1, wherein the stakeholders comprise government, private industry and academia.

3. The digital media collaboration platform of claim 1, further comprising a creative and collaboration tool set configured and arranged for the production of digital media by the stakeholders.

4. The digital media collaboration platform of claim 1, wherein the stakeholders are assigned roles.

5. The digital media collaboration platform of claim 1, wherein the stakeholders are assigned into creative teams.

6. The digital media collaboration platform of claim 1, wherein the contracts and procurement framework is further configured to provide final technical and creative project guidelines.

7. A computer-implemented method of collaborating on digital media in a networked computer environment, comprising:
providing a collaborative platform having an infrastructure with a data security model;
soliciting digital media production or making a direct request through an existing contract;
setting up project for the solicited digital media product within the collaboration platform;
setting up a production framework for the solicited digital media product within the collaboration platform;
setting up stakeholders and the data security model via the collaborative platform;
using collaboration tools to begin the production pipeline of digital media;
automating procurement through the collaborative platform of digital media; and
delivering digital media products through a secure framework within the collaborative platform.

8. The method of claim 7, further comprising assigning roles the stakeholders.

9. The method of claim 7, further comprising assigning an executive producer or creative director to gather requirements and project specification from the customer.

10. The method of claim 7, further comprising creating project guidelines using the collaborative platform.

11. The method of claim 7, further comprising creating technical guidelines using the collaborative platform.

12. The method of claim 7, wherein the stakeholders comprise government, private industry and academia.

13. The method of claim 7, further comprising assigning the stakeholders to creative teams.
